(19) United States
(12) Patent Application Publication
(10) Pub. No.: US 2026/0024520 A1
(43) Pub. Date: Jan. 22, 2026

(54) AUTOMATICALLY GENERATED AUDIO ADVENTURES FOR GUIDING THROUGH ROUTINES

(71) Applicant: Huckleberry Labs, Irvine, CA (US)

(72) Inventors: Jessica Toh, Riverside, CA (US); Seng Oon Toh, Riverside, CA (US)

(21) Appl. No.: 19/276,613

(22) Filed: Jul. 22, 2025

Related U.S. Application Data
(60) Provisional application No. 63/673,927, filed on Jul. 22, 2024.

(51) Int. Cl. G10L 13/027; G10H 1/00; G10L 13/08

(52) U.S. Cl. CPC G10L 13/027; G10H 1/0025; G10L 13/08

(57) ABSTRACT

Systems and methods are provided for generating an audio narrative. A method comprises reading a theme selection; reading a routine, the routine comprising one or more tasks; preparing one or more prompts based on the theme selection and routine, the prompts being configured to elicit a narrative; providing the one or more prompts to a generative artificial intelligence (AI) model, the generative AI model configured to create a narrative based thereon; receiving the narrative from the generative AI model; parsing the narrative into a series of steps, the series of steps corresponding to the one or more tasks associated with the routine; converting the series of story tasks from text to speech; mixing the speech with a music choice; and outputting the mixed speech and music for the routine.

### RELATED APPLICATION

This application claims the benefit of priority to U.S. Provisional App. No. 63/673,927, filed Jul. 22, 2024, which is incorporated herein by reference in its entirety.

### TECHNICAL FIELD

Embodiments of the present disclosure are related to a system, method, and computer program product for an automated process for generating an audio adventure for guiding through a routine.

### BACKGROUND OF THE DISCLOSURE

Studies have shown the importance of bedtime routines for sleep quality, dental health, school performance, BMI, social/emotional development, family function and parental socio-emotional wellbeing. However, managing bedtime routines with children can be fraught with challenges, including resistance, distractions, extended preparatory times, and delayed sleep onset, all of which contribute to a stressful environment for both caregivers and children. Traditional bedtime tasks are generally repetitive and lack the dynamic engagement necessary to maintain a child's interest consistently. This often leads to confrontations and reluctance on the part of the child, exacerbating sleep difficulties and complicating what should be a calming transition to rest. Ultimately this may lead to delayed sleep onset and shorter sleep duration, which impacts the health and development of family members.

An audio guide to keep children and adults focused and engaged with routines is needed.

### SUMMARY

The present disclosure provides an automated process for generating an audio adventure for guiding through a routine.

In an embodiment, a method for generating an audio adventure for guiding through a routine comprises: reading a theme selection; reading a routine, the routine comprising one or more tasks; preparing one or more prompts based on the theme selection and routine, the prompts being configured to elicit a narrative; providing the one or more prompts to a generative artificial intelligence (AI) model, the generative AI model configured to create a narrative based thereon; receiving the narrative from the generative AI model; parsing the narrative into a series of steps, the series of steps corresponding to the one or more tasks associated with the routine; converting the series of story tasks from text to speech; mixing the speech with a music choice; and outputting the mixed speech and music for the routine.

In some embodiments, the method further comprises checking the theme against a subject's demographic information to determine appropriateness.

In some embodiments, the subject's demographic information comprises age, developmental level, and/or one or more predetermined parameters for the subject.

In some embodiments, the method further comprises performing one or more quality check of the narrative.

In some embodiments, the method further comprises providing a subject's name to the generative AI model for incorporation into the story.

In some embodiments, the subject's name is recited during the story.

In some embodiments, the theme is input by a user.

In some embodiments, the routine comprises one of a bedtime routine, a morning routine, or a cleaning routine.

In some embodiments, the music choice is predetermined to match the theme.

In some embodiments, the audio story is saved to be recited each time the routine is performed.

In some embodiments, the method includes determining a time associated with each task of the one or more tasks.

In some embodiments, the time associated with each task is recorded.

In some embodiments, the time associated with each task is adjustable by the user.

In some embodiments, the time associated with each task is tracked with each performance of the audio story.

In some embodiments, converting the story tasks from text to speech comprises selecting a voice for the audio story.

In some embodiments, each task is associated with a best practice of the task, and the task is tailored to mirror the best practice.

In some embodiments, a pronunciation of the subject's name is input into the generative AI model.

In an alternative embodiment, A system for generating narrative audio, the system comprising: a computing node comprising a computer readable storage medium having program instructions embodied therewith, the program instructions executable by a processor of the computing node to cause the processor to perform a method comprising: reading a theme selection; reading a routine, the routine comprising one or more tasks; preparing one or more prompts based on the theme selection and routine, the prompts being configured to elicit a narrative; providing the one or more prompts to a generative artificial intelligence (AI) model, the generative AI model configured to create a narrative based thereon; receiving the narrative from the generative AI model; parsing the narrative into a series of steps, the series of steps corresponding to the one or more tasks associated with the routine; converting the series of story tasks from text to speech; mixing the speech with a music choice; and outputting the mixed speech and music for the routine.

In an alternative embodiment, a computer program product for generating narrative audio, the computer program product comprising a computer readable storage medium having program instructions embodied therewith, the program instructions executable by a processor to cause the processor to perform a method comprising: reading a theme selection; reading a routine, the routine comprising one or more tasks; preparing one or more prompts based on the theme selection and routine, the prompts being configured to elicit a narrative; providing the one or more prompts to a generative artificial intelligence (AI) model, the generative AI model configured to create a narrative based thereon; receiving the narrative from the generative AI model; parsing the narrative into a series of steps, the series of steps corresponding to the one or more tasks associated with the routine; converting the series of story tasks from text to speech; mixing the speech with a music choice; and outputting the mixed speech and music for the routine.

### BRIEF DESCRIPTION OF THE DRAWINGS

The accompanying drawings, which are incorporated into and constitute a part of this specification, illustrate various exemplary embodiments and together with the description, serve to explain the principles of the disclosed embodiments.

FIG. 1A is a flow chart that illustrates a method for creating a themed audio adventure story based on a specific routine and personalized to a child, in accordance with one or more embodiments of this disclosure.

FIG. 1B is a continuation of the flow chart of FIG. 1A.

FIG. 2 is an exemplary graphical user interface, in accordance with one or more embodiments of this disclosure.

FIG. 3 is a schematic diagram of an exemplary computing node.

### DETAILED DESCRIPTION

Reference will now be made in detail to the exemplary embodiments of the present disclosure, examples of which are illustrated in the accompanying drawings. Wherever possible, the same reference numbers will be used through-out the drawings to refer to the same or like parts.

The systems, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these devices, systems, or methods unless specifically designated as mandatory.

Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

As used herein, the term “exemplary” is used in the sense of “example,” rather than “ideal.” Moreover, the terms “a” and “an” herein do not denote a limitation of quantity, but rather denote the presence of one or more of the referenced items.

One component traditionally integrated into the bedtime routine is reading. While this practice is essential for developmental reasons—helping to build language skills, emotional intelligence, and providing a bonding experience between parent and child—it requires time and consistency. In busy family settings, or when parents are tired after a long day, time devoted to reading can be substantially compressed or skipped entirely. This truncation deprives children of the benefit of reading, and can result in feelings of neglect or a lack of routine stability, both crucial for a child's sense of security and development.

Moreover, issues may extend beyond bedtime routines to include other daily activities such as getting ready in the morning to be at school on time, cleaning up, mealtimes, and afterschool homework. Like bedtime routines, these activities often suffer from monotony and lack of engagement, posing difficulties in maintaining a smooth daily schedule and further affecting the overall family dynamics. Adults with ADHD (Attention Deficit Hyperactivity Disorder) also face challenges with maintaining daily routines as they get distracted during mundane tasks.

Alternative solutions to streamline routines include tools like chore charts and reward systems. Chore charts (both physical and digital) provide structure by visually mapping out tasks and can include reward systems to motivate compliance. Typically the task will be checked off once it is completed. Chore charts can be difficult for caregivers to implement, maintain, and reinforce. Once the novelty wears off, caregivers may find themselves reminding and negotiating with the child. For children and adults who require more frequent and immediate rewards to stay focused, typical chore charts may not offer sufficient stimulation or the right pace of feedback. When the chore chart is in a digital format (e.g., a mobile phone application) that is used to mark off each task completion, it can introduce additional screen time leading to further distractions or requests for time on the device.

A reward system may or may not be paired with a chore chart. These systems offer incentives for completed tasks, aimed at motivating children to complete the tasks. A major drawback of reward systems is that it emphasizes external rather than intrinsic rewards, which many people are hesitant to implement. It also requires coming up with a reward that is motivating enough. While incentivizing task completion, these systems can be less effective if rewards are too distant in the future or if the tasks are too long, as children or individuals with ADHD often benefit from immediate feedback to remain engaged.

Both chore charts and reward systems assume that the child knows how to complete each step adequately. Given the limitations, there is a need for a more effective solution that can engage children and adults meaningfully to provide immediate feedback, customizable interactions, and intrinsic motivation. Embodiments of the present disclosure, through interactive and adaptive auditory adventure systems, meet these needs by enveloping routine tasks within an engaging narrative that captures and sustains attention in an innovative way.

Embodiments of the present disclosure transform routine activities into a fun and immersive audio narrative that guides children through their tasks in real-time. The system utilizes a combination of storytelling, interactive prompts, and sound effects tailored to the routine steps being narrated-whether the task is brushing teeth, getting dressed, or settling down for bed.

Embodiments of the present disclosure may be operated via a smart device application, allowing parents and guardians can customize a narrative to match their specific routine, incorporate preferred characters, and even set the pace of the narration according to the child's attention span and activity level. User inputs create an on-demand personalized storyline that dynamically adapts to the user's progress through routine tasks, providing auditory incentives for each completed action. Background music matching the theme may be incorporated to increase engagement while blending in with the narrative.

The immersive narrative is played during the routine tasks, turning the routine into an engaging adventure as it guides through each task. The narrative also incorporates best practices in how to accomplish each task. For example, the narrative might invite a child who loves treasure hunts to embark on a treasure hunt through the forest (their bedroom), relating each step to the treasure hunt theme. The adventure may relate picking out clothes for the next day to finding treasure in the closet, or turn brushing teeth into polishing each tooth like they are polishing the gems they discovered, moving their brush along in little circles. The adventure may then incorporate guidance on how to properly and thoroughly brush the teeth, for the right duration of time.

Embodiments of the present disclosure may increase child engagement. Unlike passive storybooks or monotonous chore charts, this system uses interactive and dynamic storytelling that maintains attention from start to finish. Further, rewards for task completion are provided in real-time with positive feedback through the story, which is crucial for keeping engagement and motivation. This real-time interaction helps cultivate an intrinsic motivation as the child sees immediate effects of their actions within the story.

Embodiments of the present disclosure offer significant customization to cater to individual preferences and needs. Stories, characters, pace, and even the voices can be adapted, ensuring the system stays relevant and engaging as a child grows and their interests evolve. With the user-friendly interface, routines can be quickly set up and modified without needing extensive technical knowledge or time-consuming setups. With the audio narrative as the guide, implementation is easier than adherence to a physical chart or reward system. This in turn reduces dependency on external rewards; by integrating the reward system within the story, children learn to associate task completion with the progression and conclusion of a compelling narrative, fostering a healthier, intrinsic motivation to follow through with routines. This also lessens negotiation and reminders from the caregiver, as the narrative guidance results in the caregiver no longer needing to remind or nag the child to complete the tasks.

Further, embodiments of the present disclosure incorporate best practices for health and hygiene, such as tooth brushing guidance by age as outlined by the American Dental Association. This incorporation helps families learn how best to accomplish each task. Some embodiments may be applied to routines outside of bedtimes, such as for mealtimes, homework routines, or morning preparations. The adventure narration system addresses the specific needs of families, but also offers a revolutionary approach to managing and transforming routine tasks into exciting and enjoyable activities, potentially altering the dynamic of daily routines in households around the world.

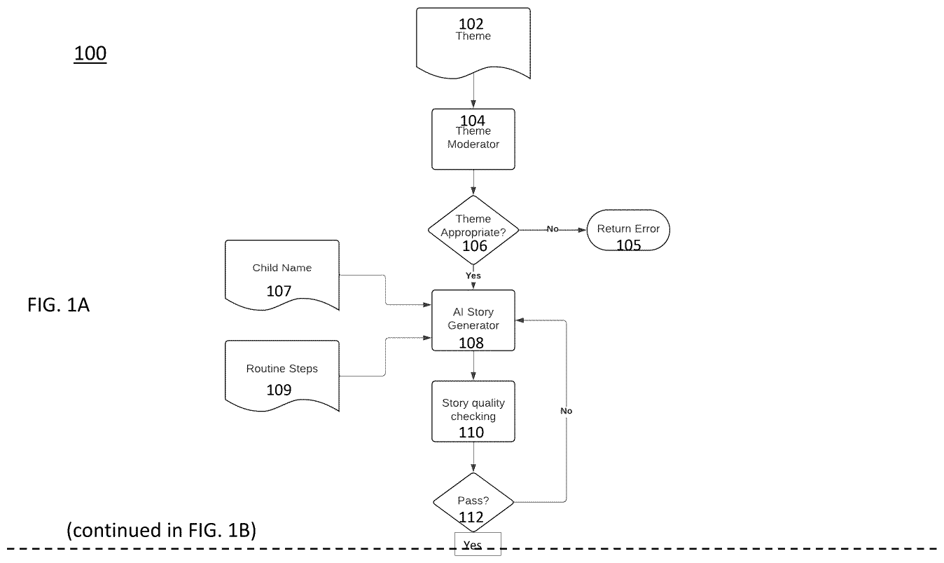

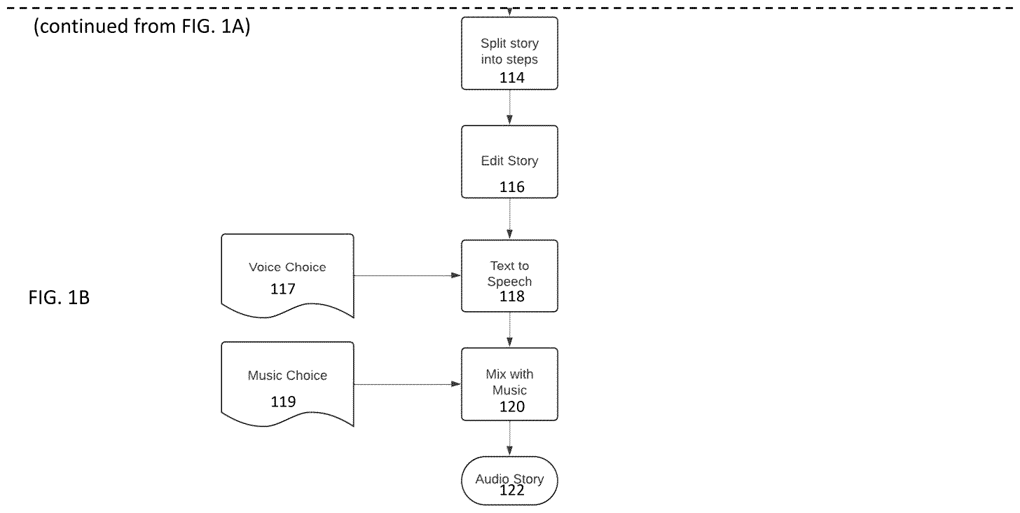

The system as illustrated by FIGS. 1A-1B collects the child's name, or nickname, as input by the user during a preprocessing process. The system enables the user to preview and further customize the pronunciation to ensure accuracy. Research shows that accurately capturing the child's name pronunciation enhances engagement and compliance. The child's birth date is also provided; the system translates the provided birth date into the child's age. This age information is used to tailor the adventure content, ensuring it is age-appropriate. For example, a 3-year-old may require simpler language and more brief instructions or narrative, compared to a 7-year-old.

Preprocessing of the system may include the determination of optimal routine steps. For greater effectiveness and fit, the right list of actions that the caregiver would like the child to complete is determined. To facilitate this, a selectable list of common and recommended steps is presented to the user via the user interface for that particular routine type. The user can select from the recommended list or add custom steps, or the care-giver can specify this list through the user interface. Default durations for each step are provided, which can also be tailored.

Certain steps are internally expanded to additional sub-steps to enrich the content for the system to generate the story, and to better guide the child. For example, “Brush teeth” may be displayed to the user but may be expanded into sub-steps including putting the toothpaste on the toothbrush, brushing each section of the teeth using a circular motion for a specified duration, and spitting, before it is sent to the system for adventure creation.

Once the routine steps are determined, a numbered list of the steps is created so that the response from the system corresponds to the list of steps with appropriate heading for each step that can be conveniently parsed in post processing.

In some embodiments, the system internationalizes the routine steps to ensure localization. For example, “use the loo” may be used in the UK, whereas “Use the potty” would be used in the US. These localized descriptions are then processed by the system to reflect familiar terminology in the resultant adventure.

Prompts engineered for the specific use case may be incorporated into some embodiments of the present disclosure. Prompts provided to the system for reference may include the following:
Start with a Warm Greeting: Begin by addressing the child directly, using a warm and friendly tone to make them feel seen and appreciated. This could involve a brief introduction that acknowledges the time of day, if known, and the upcoming routine.
Start Each Step with a Clear and Simple Statement of What to do Next: Make transitions easy for the child by clearly stating what they will be doing next.
Engage with Interactive Elements: Include interactive elements such as prompts for pretend play (e.g., “When you're done you can make superhero poses!”) or saying the child's name.
Incorporate Storytelling or Themes: Weave the routine steps within a story or theme that children find appealing. For example, you could frame the routine as a journey to a destination, where each step (like brushing teeth, putting on pajamas, etc.) is a fun part of the adventure.
Include Skill-building Guidance for certain scenarios: The user has training in how to teach kids the best way to brush their teeth as a kids' dentist would. So whenever the routine includes brushing teeth, the user includes very specific guidance to make sure they brush every part of each tooth. The system reminds them to spit whenever they need to. The user may be prompted to give a lot of detail as if they are guiding the child in real-time as they brush their teeth. The user may also have training in how to simplify cleaning up and organizing for kids. If the routine includes elements of tidying up, the user may provide guidance in how to do so in a simple way that children can understand.
End with a Goodbye Wish: End with a heartfelt wish, assuring the child that they are loved. This closure signals the end of the routine and helps children transition.
Here is what the user does not include:
   If a routine step includes choosing a specific item (e.g., pajamas, books) the user do not specify the type. This is because children can get upset if they do not have that specific type available to them, so it is better to be left unmentioned.
   The system does congratulate the child for completing a step until they are on the next step.
   The system does not include text from the actual prompt. Rather, the output is just what the user would say to the child directly.
   The system does not make any assumption about the gender of the child.
   The system does not make any assumption about the child or guidance based on their name.
Create a guided adventure that speaks directly to a child named ${childName} in 2nd person voice. Make it appropriate for a ${childAge} year old. This adventure should start with an engaging introduction that seamlessly leads into the first routine step, making it part of the adventure. The adventure should guide the child through the routine steps in a detailed way, using imaginative pretend play. The theme of this story should be: ${theme}. Relate each step back to the theme. Make it exciting.
Include exactly the following steps: ${stepsText}.
Please adhere closely to the provided steps, without adding or combining sections. Provide the number of the step and name of the step in the beginning of each step in its own line. The narrative should flow smoothly from one activity to the next, making each part of the adventure. Do not include numbered steps, emojis or anything else not easily read.

By responding to these prompts, the user can set the persona of the system agent and guidelines on how to write the adventure. Examples of responses to prompts include making sure to greet the child by name, and to include a clear statement of what each step's name is at the beginning of each story. Including the child's name automatically engages the child in the adventure, especially when it is narrated to them. Without the introduction of each step, it may not be clear to the child what action they are supposed to take. Further, without the introduction there is a tendency for the system to include a long, creative narrative up front, confusing the child as to what they are actually supposed to be doing.

Additional parameters for the system include weaving the storyline with the routine as much as possible so that it is appealing to a child; skill-building guidance (such as AAP best practices, ADA guidance) that is appropriate to a child of the age is introduced into the system through the prompt; in another approach, the system is fine-tuned with a database of guidance so that it has it available in the model when generating the adventure.

The system configures the story to address the child by name and in the second person voice, fostering an engaging narrative. The system further produces content suitable for the child's age. To ensure compliance, a secondary simplification step reprocesses the initial adventure to adjust complexity as necessary. This is done by feeding the initial generated narrative back into the system, instructing the system to simplify it.

In some embodiments, additional narrative structure can be provided. The system is instructed to “start with an engaging introduction that seamlessly leads into the first routine step, making it part of the adventure. The adventure should guide the child through the routine steps in a detailed way, using imaginative pretend play. The theme of this story should be: ${theme}. Relate each step back to the theme. Make it exciting.”

Users can select from predefined themes (e.g., dinosaurs, princesses, outer space) or input custom themes via free text. Predefined themes come with additional guidance to constrain the generated responses. For example, “outer space” might be elaborated to “An astronaut on a mission to outer space,” while “Dinosaurs” could become “a dinosaur in the Triassic era roaming among giant rainforests.” This guidance prevents the system from generating less engaging content.

The story generating module, for example, a generative artificial intelligence (AI) model, is instructed to adhere strictly to the provided steps, without adding or merging sections. Each section begins with the step number and name, ensuring the response is easily parsed. Post-processing algorithms refine sections to ensure accuracy. The story generating module is directed to create a smooth narrative flow from one activity to the next, ensuring cohesion in the storyline. The story generating module is instructed to exclude emojis and other elements that hinder readability. Post-processing algorithms remove any undesired elements that may remain, enhancing the story's narrated quality.

Some steps in a routine require a longer duration that should not include audio or narratives overlaying the step, such as reading a book with a parent. For these steps, the system automatically detects that this step could take longer either by predefining it as an attribute in an associated step library or by means of an NLP algorithm looking for custom steps that are known to take a longer time. A script is automatically inserted at the end of these step such as “Since this is a longer step, I'll stop the music for this part. Feel free to pause the audio and play the next step when you're ready.” This attribute is also used in the audio playback in the app to automatically pause the audio, depending on a user's preference.

FIG. 1A illustrates a flow chart 100 for creating a themed audio adventure story that is based on a specific routine and personalized to a child.

Flow chart 100 starts with the selection of a theme 102 by the user. Possible themes may include subjects such as princesses, sports, or other predefined subjects of interest to children. In some embodiments, users can select a theme from a list of predefined themes (e.g., dinosaurs, princesses, outer space) or input custom themes via free text. A theme moderator 104 may be used to ensure the theme should be flagged for any of the following content: sexual, hate, harassment, self-harm, sexual/minors, hate/threatening, violence/graphic, self-harm/intent, self-harm/instructions, harassment/threatening, violence. The theme may then be determined to be appropriate in step 106; if the theme is judged to be inappropriate, a return error 105 may appear to a user. Whether the theme is determined to be appropriate or not may depend on input system parameters such as child age, development stage, or other customizable input information. Additional inputs such as a child's name 107 and routine steps 109 can be input into the AI story generator 108 to ensure that the adventure is customized. Once the AI story generator 108 generates the story for the child, a story quality check 110 occurs to ensure that the story refers to the child by name, the number of tasks within the generated story matches the number of routine steps 107 input, and whether there are any stereotypical gender references in the generated storyline. If the quality check 110 fails, a request is resent to the AI story generator 108. If the quality check 110 passes, as shown in step 112, the process continues to the steps shown in FIG. 1B.

Quality check 110 may be completed by sending another request to the generative AI model. If any of the quality assurance checks failed, the request with the generative AI model is retried up to a programmable number of times. If the adventure is for a child that is below a certain age (for example 4 years old), the script is reprocessed in the generative AI model, with an instruction for it to be simplified for a 3 year old child while maintaining the same adventure structure and storyline.

FIG. 1B continues to illustrate flow chart 100. Once the quality check 110 passes in step 112, the generated story is split into steps 114. In some embodiments, a text parser is implemented in step 114 to break up the full adventure response from the generative AI model into sections that match the steps in the routine. This is critical as the audio generation routine needs to insert delays after each step narration, corresponding to the length of the routine. The text parser may also remove any emojis and any special characters that are not easily read. The post-processed and parsed text is returned to the app user interface.

The story is then edited at step 116, where the user is given the opportunity to review and edit the narrative output using a text editor built into the system. The resulting text is then sent to a backend server process for generating audio from the adventure text in a text to speech step 118. The user is also given a choice of the voice 117 that will be used for narration. The generated text is then mixed with music in step 120. Predefined themes are assigned with predefined background music that has been selected to match the theme. If a custom theme was selected, the user is given the option to choose the music in step 119. The music, voice, custom name pronunciation, step durations, optional step pause attribute are sent to a backend server process for audio generation.

In step 122, the audio is generated for the story. Custom name pronunciations are substituted in the adventure, in place of the child's name. Speech for the adventure is synthesized using any of a variety of speech synthesis techniques known in the art. When available, a speech accent is used that matches the user's locale. For example, if the user is in the UK, the audio narrator uses a UK accent. The speech generation is also able to generate narration in different languages.

The speech synthesis file is split up into individual sections corresponding to each step in the routine. Additional delays are added to the narration in the case where a step duration is longer than the narration (for example, 2 minutes to brush teeth but the narration only took 30 seconds). In the case where the narration is longer than the requested duration (e.g., giving parents a hug only takes 10 seconds but the narration took 30 seconds), the step duration is extended to match the narration duration so that the narration is not chopped.

A background music with matching length is generated to match the routine length. This is done by combining different sections of a music piece programmatically, making sure the beats and music progression match up in the combination. The music is automatically faded out when the step is being narrated and faded back in for the remainder of the step. This is to help make the adventure narration more audible. In the case of steps with a pause introduced, the music fades to a complete silence for the remainder of the step. For example, if the step was to read a book, the music would fade to silence, to provide a quiet environment for book reading.

The combined adventure audio file is sent back to the system, together with bookmarking metadata to indicate where in the audio file to seek to for each step.

The system learns from usage patterns over time. Upon selecting a routine, the user is presented with a list of suggested steps and recommended durations per step. The system employs an intelligent algorithm that adapts the storytelling narration to match the child's language capabilities based on their age.

The system monitors the time the child actually takes to complete a step by calculating the average of the last three times it was completed, incorporating pauses, rewinds, and fast forwards, but excluding outliers. The system updates the default duration of the step, thereby optimizing the routine flow and reducing the need for the user to manually adjust the audio playback while the routine is happening.

The algorithm is also equipped to expand simple steps into detailed multi-step processes where necessary. For example, the task of “brushing teeth” can be divided into multiple steps covering all quadrants of the mouth, ensuring thorough guidance during the routine. The multistep divisions are initially pre-defined according to expert knowledge of typical routines but are enhanced through machine learning techniques such as NLP clustering to identify common steps across users. The routine suggestions evolve as more user data is collected, making the algorithm more personalized and effective over time.

As the child progresses in age and cognitive abilities, the system intelligently proposes increasingly complex tasks that the child can manage, using an AI-driven “next best action” model. This model uses collected data to forecast the child's readiness for more advanced routines, presenting suggestions for additional tasks directly to the caregiver.

Embodiments of the present disclosure include a primary user interface. The interface may be an application accessible via smartphones or tablets. This interface allows caregivers to input personalized details of the child including name, age, and specific pronunciation adjustments to tailor the narrative experience. The interface facilitates the setup of both common routine types—such as bedtime, morning, or clean-up routines—and more customized routines tailored to specific tasks (e.g., preparing for school, doing chores, or using the toilet).

The audio adventure stories are presented through a playback interface displaying all routine steps, allowing caregivers to manually advance to the next task if a child completes a step earlier than anticipated. Interaction with the interface, such as the duration taken to complete a step, is diligently recorded to facilitate performance tracking and retrospective analysis through summary charts and statistics.

The user may opt to receive notification reminders on their device to begin their routine. In the example of a bedtime routine, it may alert them when they should begin the bedtime routine in order to be in bed by their desired time, based on how long it typically takes the child to go through the routine.

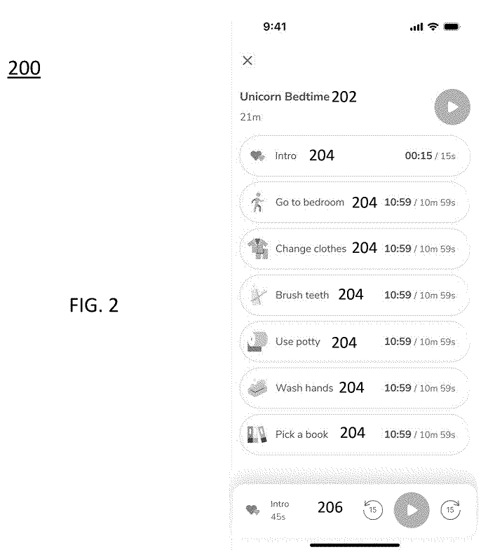

FIG. 2 illustrates an exemplary playback interface 200. The generated story 202, here labelled as “Unicorn Bedtime,” comprises a series of tasks 204. Each task 204 is labelled and provides a recommended time period for completion of the task. An introduction button 206 is selected when the user is ready for the routine to begin.

In some embodiments, the system supports integration with voice assistants, including Amazon Alexa, Google Assistant, and Siri, allowing for seamless interaction via voice commands. Additionally, the system can connect with various smart home devices through platforms like Apple Home Kit or Google Home. Such integration enables the orchestration of a multisensory adventure across multiple rooms. For instance, as the narrative progresses, smart lights can guide the child to the next activity location with specified colors, and smart speakers in different rooms can continue the story as the child moves through the space. This holistic approach not only entertains but also helps in managing the child's movements through the tasks, concluding with the lights dimming as the bedtime story ends and the child is ready to sleep.

Embodiments of the present disclosure offer a novel solution to routine management by transforming mundane tasks into an interactive, adaptive narrative experience that captively guides children through their daily activities. Unlike existing solutions that struggle with sustained engagement and customization, this system provides dynamic content and real-time adjustments to routines based on observed interactions and AI-driven forecasts. This level of personalization not only enhances engagement but also significantly aids in developing autonomy and responsibility in children and adults-particularly benefiting those with attention-related challenges such as ADHD.

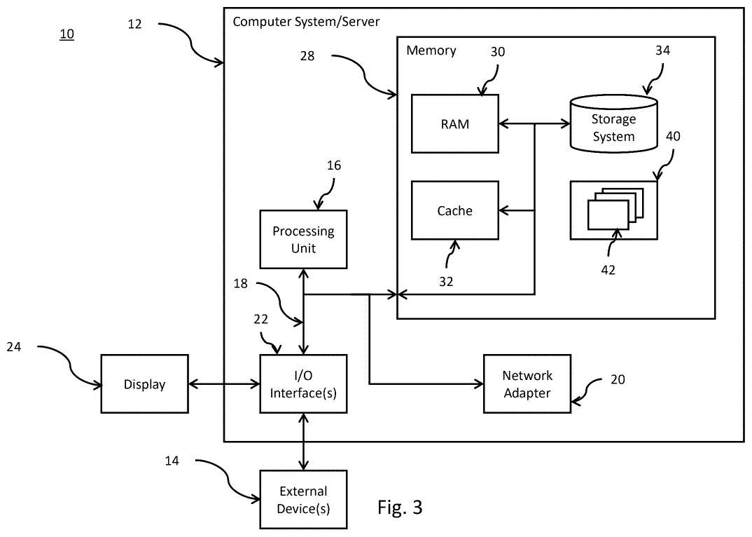

Referring now to FIG. 3, a schematic of an example of a computing node is shown. Computing node 10 is only one example of a suitable computing node and is not intended to suggest any limitation as to the scope of use or functionality of embodiments described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 3, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed:

1. A method for generating narrative audio, the method comprising:
reading a theme selection;
reading a routine, the routine comprising one or more tasks;
preparing one or more prompts based on the theme selection, the prompts being configured to elicit a narrative;
providing the one or more prompts to a generative artificial intelligence (AI) model, the generative AI model configured to create a narrative based thereon;
receiving the narrative from the generative AI model;
parsing the narrative into a series of steps, the series of steps corresponding to the one or more tasks associated with the routine;
converting the series of story tasks from text to speech;
mixing the speech with a music choice; and
outputting the mixed speech and music for the routine.

2. The method of claim 1, further comprising checking the theme against a subject's demographic information to determine appropriateness.

3. The method of claim 2, wherein the subject's demographic information comprises age, developmental level, and/or one or more predetermined parameters for the subject.

4. The method of claim 1, further comprising performing one or more quality check of the narrative.

5. The method of claim 1, further comprising providing a subject's name to the generative AI model for incorporation into the story.

6. The method of claim 5, wherein the subject's name is recited during the story.

7. The method of claim 1, wherein the theme comprises a predetermined subject.

8. The method of claim 1, wherein the theme is input by a user.

9. The method of claim 1, wherein the routine comprises one of a bedtime routine, a morning routine, or a cleaning routine.

10. The method of claim 1, wherein the music choice is predetermined to match the theme.

11. The method of claim 1, wherein the audio story is saved to be recited each time the routine is performed.

12. The method of claim 1, further comprising determining a time associated with each task of the one or more tasks.

13. The method of claim 12, wherein the time associated with each task is recorded.

14. The method of claim 12, wherein the time associated with each task is adjustable by the user.

15. The method of claim 12, wherein the time associated with each task is tracked with each performance of the audio story.

16. The method of claim 1, wherein converting the story tasks from text to speech comprises selecting a voice for the audio story.

17. The method of claim 1, wherein each task is associated with a best practice of the task, and the task is tailored to mirror the best practice.

18. The method of claim 1, wherein a pronunciation of the subject's name is input into the generative AI model.

19. A system for generating narrative audio, the system comprising:
a computing node comprising a computer readable storage medium having program instructions embodied therewith, the program instructions executable by a processor of the computing node to cause the processor to perform a method comprising:
reading a theme selection;
reading a routine, the routine comprising one or more tasks;
preparing one or more prompts based on the theme selection, the prompts being configured to elicit a narrative;
providing the one or more prompts to a generative artificial intelligence (AI) model, the generative AI model configured to create a narrative based thereon;
receiving the narrative from the generative AI model;
parsing the narrative into a series of steps, the series of steps corresponding to the one or more tasks associated with the routine;
converting the series of story tasks from text to speech;
mixing the speech with a music choice; and
outputting the mixed speech and music for the routine.

20. A computer program product for generating narrative audio, the computer program product comprising a computer readable storage medium having program instructions embodied therewith, the program instructions executable by a processor to cause the processor to perform a method comprising:
reading a theme selection;
reading a routine, the routine comprising one or more tasks;
preparing one or more prompts based on the theme selection, the prompts being configured to elicit a narrative;
providing the one or more prompts to a generative artificial intelligence (AI) model, the generative AI model configured to create a narrative based thereon;
receiving the narrative from the generative AI model;
parsing the narrative into a series of steps, the series of steps corresponding to the one or more tasks associated with the routine;
converting the series of story tasks from text to speech;
mixing the speech with a music choice; and
outputting the mixed speech and music for the routine.
